(19) United States
(12) Patent Application Publication
(10) Pub. No.: US 2013/0340046 A1
(43) Pub. Date: Dec. 19, 2013

(54) WIRELESS NETWORK CLIENT-AUTHENTICATION SYSTEM AND WIRELESS NETWORK CONNECTION METHOD THEREOF

(71) Applicant: WISTRON CORPORATION, New Taipei City (TW)

(72) Inventors: Pei-Ling YU, New Taipei City (TW); Victor CHANG, New Taipei City (TW); Wei-Cherng LIAO, New Taipei City (TW)

(73) Assignee: WISTRON CORPORATION, New Taipei City (TW)

(21) Appl. No.: 13/782,434

(22) Filed: Mar. 1, 2013

(30) Foreign Application Priority Data
Jun. 18, 2012 (TW) 101121753

(51) Int. Cl. H04L 29/06

(52) U.S. Cl. CPC H04L 63/08
USPC 726/4

(57) ABSTRACT

A wireless network client-authentication system and a wireless network connection method thereof are disclosed. The wireless network client-authentication system includes a network service system, a wireless router, and an electronic device. The network service system has an administrator interface module for managing a client list. The wireless router is used for uploading connection information to the network service system. The electronic device is capable of transmitting a signal via a first communication path and a second communication path. A connection module of the electronic device is used for logging in the network service system via the first communication path by a user account. The administrator interface module determines whether the user account is corresponding to the client list. If yes, the administrator interface allows the connection module to connect to the wireless router via the second communication path with the connection information.

### BACKGROUND OF THE INVENTION

1. Field of the Invention

The present invention relates to a wireless network client-authentication system and a wireless network connection method thereof, and more particularly, to a wireless network client-authentication system capable of using a network service system for management and a wireless network connection method thereof.

2. Description of the Related Art

With the development of science and technology, the use of electronic devices such as mobile phones, tablet PCs, or notebook computers have become popular; meanwhile, the electronic devices are typically provided with the wireless network function, such as connected to a network through the Wi-Fi protocol transmission provided by a wireless router. The provider of wireless routers usually manages wireless routers by using a variety of encryption schemes, such as WEP/WPA/WPA2-PSK mode, which allows a user to enter the permitted password via the electronic device before using the wireless router. However, using a smaller mobile phone to enter the password would be more inconvenient. Meanwhile, the provider of wireless routers needs to use several steps to set up the wireless router, and thus it is not easy and convenient to set a permitted list or authority for different users.

Accordingly, it is necessary to provide a new wireless network client-authentication system and a wireless network connection method thereof to solve the defects occurred in the prior art.

### SUMMARY OF THE INVENTION

It is a major objective of the present invention to provide a wireless network client-authentication system having the function of using a network service system for management.

It is another objective of the present invention to provide a wireless network connection method used in the above-mentioned system.

In order to achieve the above objects, the wireless network client-authentication system in the present invention comprises a network service system, a wireless router, and an electronic device. The network service system has an administrator interface module for managing a client list. The wireless router is connected to the administrator interface module of the network service system for uploading a connection information to the network service system, wherein the connection information includes an encryption scheme. The electronic device is capable of transmitting signals via a first communication path and a second communication path. The electronic device has a connection module which is connected to the network service system via the first communication path to login the network service system by a user account. The administrator interface module determines whether the user account is corresponding to the client list. If yes, the administrator interface module allows the connection module of the electronic device to connect to the wireless router via the second communication path with the connection information.

The wireless network connection method of the present invention comprises the following steps: performing an initial setup process for the wireless router, which comprises the steps of: logging in the administrator interface module of the network service system through the wireless router; and allowing the wireless router to set a connection information and upload the connection information to the network service system, wherein the connection information comprises an encryption scheme; and implementing a connection process, comprising: allowing the electronic device to connect to the network service system via the first communication path and login the network service system by a user account; determining whether the user account is corresponding to the client list; if yes, allowing the electronic device to connect to the wireless router via the second communication path with the connection information.

### BRIEF DESCRIPTION OF THE DRAWINGS

FIG. 1 is an architecture diagram of the wireless login system of the present invention;

FIG. 2 is a flowchart illustrating the steps of the wireless network connection method of the present invention;

FIG. 3 is a flowchart illustrating the connection procedures of the first embodiment of the present invention;

FIG. 4 is a flowchart illustrating the connection procedures of the second embodiment of the present invention;

FIG. 5 is a flowchart illustrating the connection procedures of the third embodiment of the present invention; and

FIG. 6 is a flowchart illustrating the connection procedures of the fourth embodiment of the present invention.

### DETAILED DESCRIPTION OF THE PREFERRED EMBODIMENT

The advantages and innovative features of the invention will become more apparent from the following detailed description when taken in conjunction with the accompanying drawings.

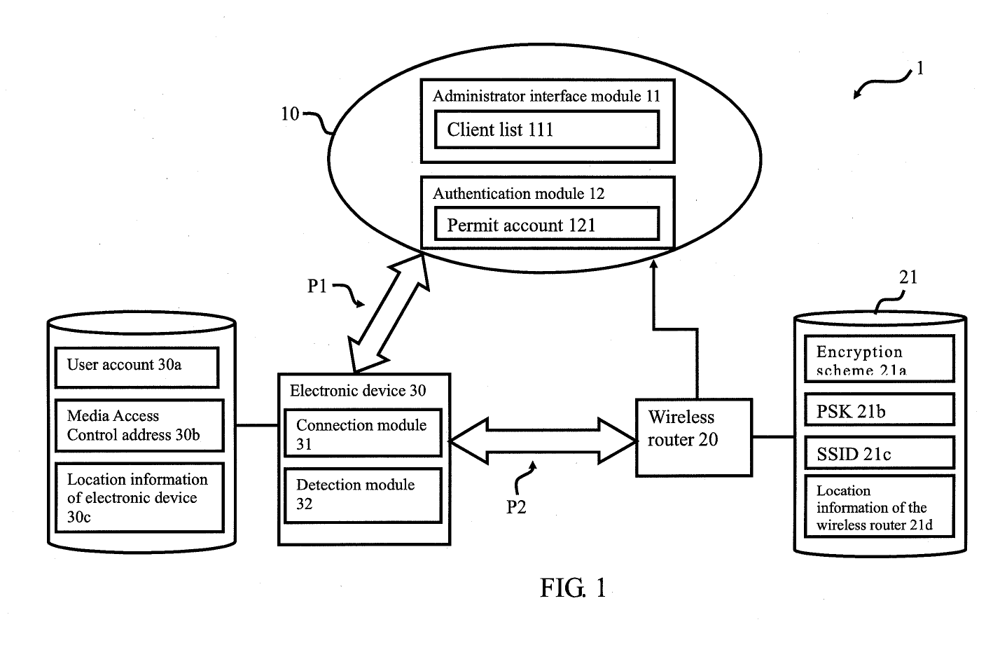

Please first refer to FIG. 1, which is an architecture diagram of the wireless network client-authentication system of the present invention.

The wireless network client-authentication system 1 of the present invention comprises a network service system 10, a wireless router 20, and an electronic device 30. The electronic device 30 can be connected with the wireless router 20 by the network service system 10. The network service system 10 can be a social networking service (SNS) website, such as FACEBOOK® or Windows Live® Messenger Service, but the present invention is not limited to this. The network service system 10 has an administrator interface module 11 for an administrator to login by a respective account and manage user accounts of a client list 111 using the administrator interface module 11. For example, the administrator interface module 11 can be used to manage a friend list, a family list or a list of fan group, etc. Although the lists mentioned above are different, but they all belong to different embodiments of the client list 111 within the protection scope of the present invention. A user can create an account by which adding himself to the above-mentioned client list 111. Since the approach to create the client list 111 has been obvious to those skilled in the art and widely applied to a variety of network service systems 10, and thus its principle will not be repeated.

The network service system 10 can also comprise an authentication module 12 which can be a Remote Authentication Dial In User Service (RADIUS) for an administrator to create a permit account 121 and provide different authentication code or different user authorities for different user accounts. It should be noted that each module of the network service system 10 described above can be made up by hardware or a combination of software and a software storage device, but the present invention is not limited to this.

The wireless router 20 has a network connection function and can be connected to the network service system 10. When the wireless router 20 is initially used, the administrator is allowed to perform an initial setup for the wireless router 20. That is, the administrator uses an equipment such as a computer system (not shown) to connect to the wireless router 20 through wired connection to login the administrator interface module 11 of the network service system 10 for setup or uploading the connection information of the wireless router 20 to the network service system 10, wherein the connection information of the wireless router 20 can comprise a service set identifier (SSID) 21c, a pre-shared key (PSK) 21b, and a location information of the wireless router 21d, but the present invention is not limited to the matters described above. In addition, the connection information can also comprise a variety of encryption schemes 21a included in the wireless router 20, such as Wireless Encryption Protocol (WEP), WPA (Wi-Fi Protected Access) or WPA2, etc. The administrator can set up the encryption scheme 21a of the wireless router 20 when setting the connection information.

The electronic device 30 can be a device such as a smart phone, a tablet PC, or a notebook computer, capable of transmitting signals via a first communication path P1 and a second communication path P2. The first communication path P1 may be a mobility protocol transmission path, such as 3G, 3.5G, or 4G protocol. The first communication path P1 may also be a wired transmission path. The second communication path P2 is a wireless LAN transmission path, e.g. Wi-Fi protocol transmission path in accordance with the IEEE 802.11 standard. The electronic device 30 comprises a connection module 31 and a detection module 32, wherein each module can be made up by hardware, a combination of hardware and firmware, or a combination of hardware and software. The electronic device 30 can increase or expand functionalities of the connection module 31 and the detection module 32 through App download. The connection module 31 is used for allowing the electronic device 30 to connect to the network service system 10 or the wireless router 20. In the embodiment of the present invention, a user first uses the connection module 31 of the electronic device 30 to connect to the network service system 10 via the first communication path P1, and logins in the network service system 10 by a user account 30a. After the administrator interface module 11 confirms that the user account 30a is corresponding to the client list 111, the electronic device 30 can obtain the connection information 21 of the wireless router 20 and allow the connection module 31 to connect to the wireless router 20 by the connection information 21 via the second communication path P2. The detection module 32 is used for searching for a signal of the wireless router 20 surrounding the electronic device 30. In one of the embodiments of the present invention, the detection module 32 first searches for the service set identifier 21c of the wireless router 20, and then gets connected through the connection module 31. Various embodiments for connecting the electronic device 30 and wireless router 20 provided in the present invention will be described hereinafter, and thus the related description will not be repeated.

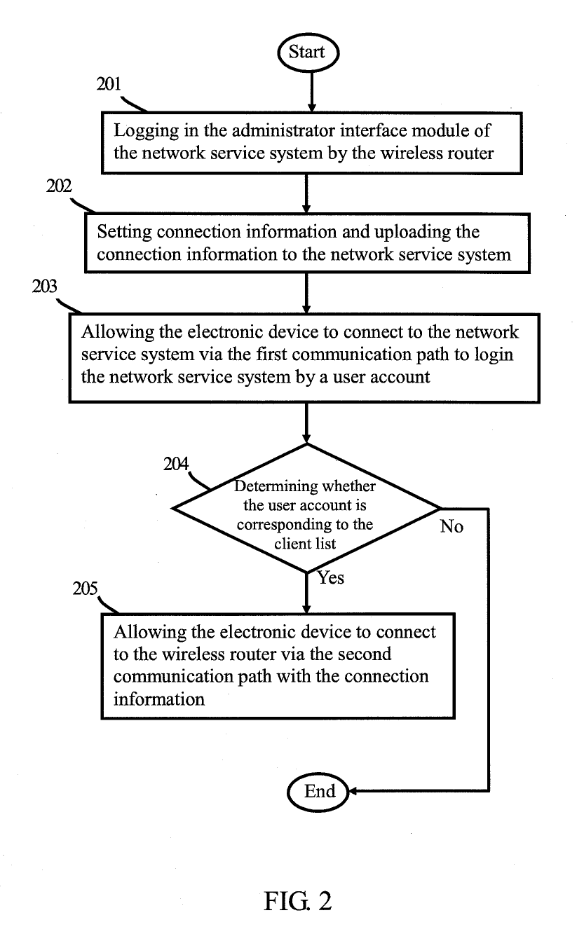

Then, please refer to FIG. 2, which is a flowchart illustrating the steps of the wireless network connection method of the present invention. It should be noted that the network service system 10 of the wireless network client-authentication system 1 is used as an example afterwards for describing the wireless network connection method in the present invention, but the wireless network connection method of the present invention is not limited to the wireless network client-authentication system 1 described above and the network service system 10, wireless router 20, and electronic device 30 thereof.

The wireless network connection method of the present invention can be separated into a step of performing an initial setup by the wireless router 20 and a step of allowing the electronic device 30 to be connected. As such, at first, perform step 201: logging in the administrator interface module of the network service system by the wireless router.

First, when wireless LAN is provided, an administrator uses the wireless router 20 for network connection and connects to the network service system 10 for logging in the administrator interface module 11.

Next, perform step 202: setting connection information and uploading the connection information to the network service system.

Next, the administrator set the connection information of the wireless router 20, such as setting the encryption scheme 21a, pre-shared key 21b, service set identifier 21c, and a location information of the wireless router 21d, by the administrator interface module 11, but the present invention is not limited to these. Then, the administrator interface module uploads the connection information and saves the connection information in the wireless router 20.

Through the step 201 and 202 described above, the administrator can complete the initial setup by the administrator interface module 11.

In order to use the electronic device 30 to connect to the wireless router 20, the user needs to first perform step 203: allowing the electronic device to connect to the network service system via the first communication path to login the network service system by a user account.

The user can allow the connection module 31 of the electronic device 30 to connect the network service system 10 via the first communication path P1, and use the preset user account 30a to login the network service system 10. When the electronic device 30 is a smart phone or a tablet PC, the first communication path P1 can be a mobility protocol transmission path. However, when the electronic device 30 is not provided with the mobile transmission protocol function, the first communication path P1 can a also be a wired transmission path, i.e. the electronic device 30 is connected first to a modem (not shown) via a wired transmission path and then connected to the network service system 10, or the electronic device 30 is directly connected to the network service system 10 through the wireless router 20 via a wired transmission path.

Then, perform step 204: determining whether the user account is corresponding to the client list.

After the electronic device 30 is used to login the network service system 10 via the first communication path P1, the administrator interface module 11 determines whether the user account 30a to login is corresponding to the client list 111. If the user account 30a to login is not included in the client list 111, the administrator interface module 11 determines that the connection of the electronic device 30 failed, and thus the connection process is ended.

If the comparison results of the administrator interface module 11 show that the user account 30a is included in the client list 111, then perform step 205: allowing the electronic device to connect to the wireless router via the second communication path with the connection information.

The administrator interface module 11 allows the electronic device 30 to connect to the wireless router 20 via the second communication path P2 with the connection information, wherein the second communication path P2 is a Wi-Fi protocol transmission path. The administrator interface module 11 allows the electronic device 30 to connect to the wireless router 20 in different ways according to different encryption schemes. Please also refer to the following detailed description about all the different embodiments related to the encryption schemes in the present invention.

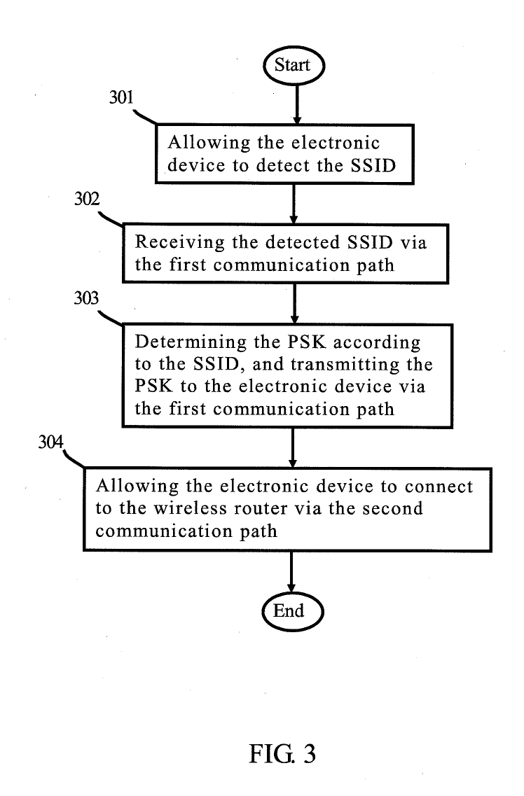

Please refer to FIG. 3, which is a flowchart illustrating the connection procedures of the first embodiment in the present invention.

In the first embodiment of the present invention, the encryption scheme 21a of the wireless router 20 is a WEP/WPA/WPA2-PSK mode. Therefore, the connection information set by the wireless router 20 and uploaded to the administrator interface module 11 at least comprises a pre-shared key 21b and a service set identifier 21c. As a result, step 301 to step 304 described below can be included in the step 205.

At first, when the administrator interface module 11 confirms the user account 30a is corresponding to the client list 111, perform step 301: allowing the electronic device to detect the SSID.

First, the administrator interface module 11 allows the detection module 32 of the electronic device 30 to detect the service set identifier 21c of the wireless router 20. The detection module 32 can detect all service set identifiers 21c near the electronic device 30, and this is not limited to only finding out one service set identifier 21c.

Then, perform step 302: receiving the detected SSID via the first communication path.

Then, the connection module 31 of the electronic device 30 transmits the detected service set identifier to the network service system 10 via the first communication path P1, and the administrator interface module 11 is allowed to receive the detected service set identifier. Since the detection module 32 may detect a plurality of service set identifiers at the same time, the administrator interface module 11 further determines whether the service set identifiers are corresponding to the service set identifier 21c of the wireless router to find out the correct service set identifier 21c.

Then, perform step 303: determining the PSK according to the SSID, and transmitting the PSK to the electronic device via the first communication path.

Therefore, after the administrator interface module 11 finds out the corresponding service set identifier 21c, the administrator interface module 11 also finds out the corresponding pre-shared key 21b according to the service set identifier 21c. Then, the administrator interface module 11 transmits the pre-shared key 21b back to the electronic device 30 via the first communication path P1.

At last, perform step 304: allowing the electronic device to connect to the wireless router via the second communication path.

Finally, after the pre-shared key 21b is transmitted back to the electronic device 30 via the first communication path P1, the electronic device 30 can be connected to the wireless router 20 via the second communication path P2 through network connection for data transmission.

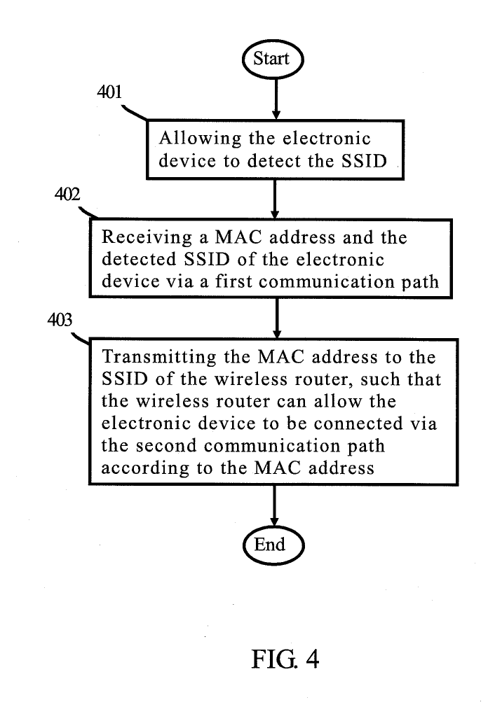

Then, please refer to FIG. 4, which is a flowchart illustrating the connection procedures of the second embodiment of the present invention.

In the second embodiment of the present invention, the encryption scheme 21a of the wireless router 20 is a directly increased Media Access Control address mode. Therefore, the connection information set by the wireless router 20 and uploaded to the administrator interface module 11 at least comprises a service set identifier 21c. As a result, the step 205 may comprise the steps 401-403 described below.

First, when the administrator interface module 11 confirms that the user account 30a is corresponding to the client list 111, perform step 401: allowing the electronic device to detect the SSID.

First, the administrator interface module 11 allows the detection module 32 of the electronic device 30 to detect the service set identifier 21c of the wireless router 20. The detection module 32 can simultaneously detect all service set identifiers near the electronic device 30, and this is not limited to only finding out one service set identifier.

Then, perform step 402: receiving a Media Access Control address and the detected SSID of the electronic device via a first communication path.

Next, the connection module 31 of the electronic device 30 transmits the Media Access Control address 30b of the electronic device 30 to the network service system 10 via the first communication path P1. Meanwhile, the connection module 31 transmits the service set identifier detected by the detection module 32 to the network service system 10, which allows the administrator interface module 11 to find out the service set identifier 21c corresponding to the wireless router 20.

Finally, perform step 403: transmitting the Media Access Control address to the SSID of the wireless router, such that the wireless router can allow the electronic device to be connected via the second communication path according to the Media Access Control address.

Accordingly, after the administrator interface module 11 finds that the service set identifier 21c is corresponding to the wireless router 20, the administrator interface module 11 transmits the Media Access Control address 30b of the electronic device 30 to the wireless router 20. Therefore, wireless router 20 can actively be connected to the connection module 31 of the electronic device 30 according to the Media Access Control address 30b.

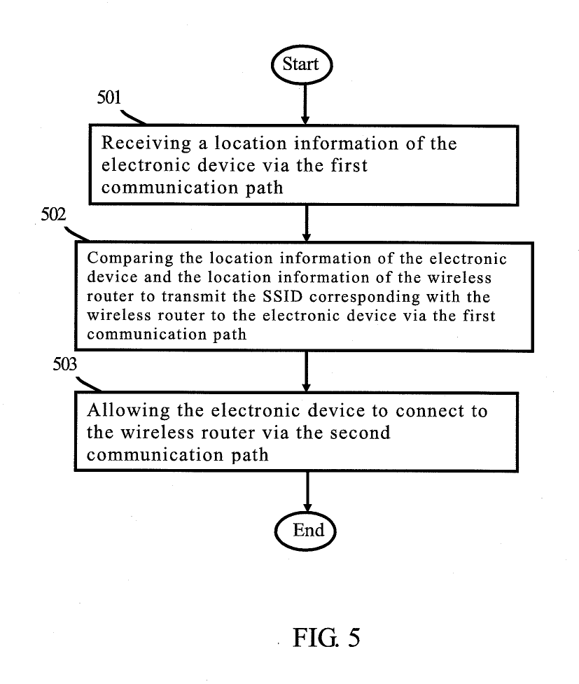

Then, please refer to FIG. 5, which is a flowchart illustrating the connection procedures of the third embodiment of the present invention.

In the third embodiment of the present invention, the encryption scheme 21 of the wireless router 20 is a mode for hiding the service set identifier 21c. Therefore, the connection information set by the wireless router 20 and uploaded to the administrator interface module 1 at least comprises the service set identifier 21c and a location information of wireless router 21d. As a result, step 205 may comprise the steps 501-503 described below.

First, when the administrator interface module 11 confirms that the user account 30a is corresponding to the client list 111, perform step 501: receiving a location information of the electronic device via the first communication path.

In the third embodiment, since the wireless router 20 hide the service set identifier 21c, the detection module 32 of the electronic device 30 is unable to find out the service set identifier 21c directly. As a result, the electronic device 30 transmits the location information of the electronic device 30c to the network service system 10 via the first communication path P1.

Then, perform step 502: comparing the location information of the electronic device and the location information of the wireless router to transmit the SSID corresponding with the wireless router to the electronic device via the first communication path.

Then, the administrator interface module 11 compares the location information of the electronic device 30c uploaded by the electronic device 30 and the set location information of the wireless router 21d. As a result, the wireless router 20 near the electronic device 30 that allows the electronic device 30 to be connected can be found. Therefore, after the comparison, the administrator interface module 11 transmits the service set identifier 21c of the wireless router 20 to the electronic device 30 via the first communication path P1.

At last, perform step 503: allowing the electronic device to connect to the wireless router via the second communication path.

Finally, after the service set identifier 21c is transmitted back to the electronic device 30 via the first communication path P1, the electronic device 30 can get the service set identifier 21c by which the electronic device 30 can be connected to the wireless router 20 via the second communication path P2 through network connection for data transmission.

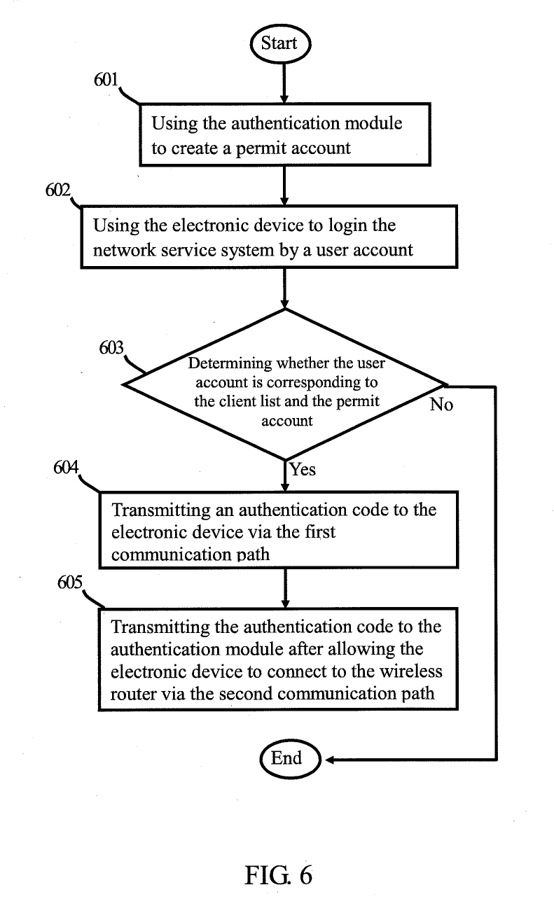

Finally, please refer to FIG. 6, which is a flowchart illustrating the connection procedures of the fourth embodiment of the present invention.

In the fourth embodiment of the present invention, the encryption scheme 21a of the wireless router 20 is a WPA2-Enterprise mode. Therefore, the network service system 10 is provided with an authentication module 12 for logging in the authentication module 12 in the electronic device 30 by an authentication code.

As a result, in the fourth embodiment of the present invention, first perform step 601: using the authentication module to create a permit account.

Administrator interface module 11 first creates a permit account 121 by the authentication module 12 to provide the authentication code for the user. Different from the client list 111 above, the administrator interface module 11 can provide different authentication code and different connection authority for each user account in the permit account 121. Therefore, it is convenient for the administrator interface module 11 to manage different user accounts.

Then, perform step 602: using the electronic device to login the network service system by a user account, and perform step 603: determining whether the user account is corresponding to the client list and the permit account.

Then, the connection module 31 of the electronic device 30 is connected to the network service system 10 via the first communication path P1, and the user can use the preset user account 30a to login the network service system 10. At this time, the administrator interface module 11 determines whether the user account 30a to login is corresponding to the client list 111 and the permit account 121. The above-mentioned step 602 and step 603 are similar to the step 203 and step 204, and thus the related description is not repeated herein.

When the administrator interface module 11 confirms that the user account 30a is corresponding to the client list 111, perform step 604: transmitting an authentication code to the electronic device via the first communication path.

When the user account 30a of the electronic device 30 is corresponding to the client list 111, the administrator interface module 11 simultaneously finds out the authentication code of the user account 30a that corresponds to the permit account 121, and then transmits the authentication code to the connection module 31 of the electronic device 30 via the first communication path P1.

Finally, perform step 605: transmitting the authentication code to the authentication module after allowing the electronic device to connect to the wireless router via the second communication path.

Finally, the connection module 31 of the electronic device 30 is connected to the wireless router 20 via the second communication path P2, and thus the user can login the authentication module 12 of the network service system 10 by the authentication code. Accordingly, the electronic device 30 needs to pass the authentication from the authentication module 12 of the network service system 10 via the second communication path P2, and further to transmit data after network connection.

It should be noted that the wireless network connection method of the present invention is not limited to the sequence of steps described above. As long as the objectives of the present invention can be achieved, the sequence of steps above can be changed with different combinations. That is, the first to third embodiments of the present invention can be combined with each other, or the fourth embodiment can be combined with the other three embodiments. Through a combination of the encryption schemes in different embodiments, a better protective effect can be achieved.

Through the wireless login system 1 of the present invention, the user can login directly to a wireless network in all kinds of occasions by the electronic device 30. For instance, the user can allow the electronic device 30 to automatically access a wireless network when entering a coffee shop, conference room or other meeting place. Administrators can easily manage the wireless router 20 without the complicated setup process.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A wireless network client-authentication system comprising:
a network service system, having an administrator interface module for managing a client list;
a wireless router, connected to the administrator interface module of the network service system for uploading a connection information to the network service system, wherein the connection information comprises an encryption scheme; and
an electronic device, capable of transmitting signals via a first communication path and a second communication path, the electronic device having a connection module connected to the network service system via the first communication path to login the network service system by a user account;
wherein the administrator interface module determines whether the user account is corresponding to the client list;
if yes, the administrator interface module allows the connection module of the electronic device to connect to the wireless router via the second communication path with the connection information.

2. The wireless network client-authentication system as claimed in claim 1, wherein:
the connection information comprises a pre-shared key (PSK) and a service set identifier (SSID);
the electronic device further comprises a detection module for detecting the service set identifier; after logging in the network service system, the connection module transmits the service set identifier to the network service system via the first communication path; and
the administrator interface module finds out the pre-shared key by the service set identifier and transmits the pre-shared key to the electronic device via the first communication path to allow the connection module of the electronic device connecting to the wireless router via the second communication path.

3. The wireless network client-authentication system as claimed in claim 1, wherein:
the connection information comprises a service set identifier;
the electronic device further comprises a detection module for detecting the service set identifier; after logging in the network service system, the connection module transmits a Media Access Control (MAC) address and the detected service set identifier to the network service system via the first communication path; and
the administrator interface module transmits the Media Access Control address to the wireless router which is having the service set identifier so that the wireless router allows for the connection of the electronic device according to the Media Access Control address.

4. The wireless network client-authentication system as claimed in claim 1, wherein:
the connection information comprises a service set identifier (SSID) and a location information of the wireless router;
the connection module of the electronic device transmits a location information of the electronic device to the network service system via the first communication path after logging in the network service system; and
after comparing the location information of the electronic device and the location information of the wireless router, the administrator interface module transmits the service set identifier corresponding to the wireless router to the connection module via the first communication path, which allows the electronic device to connect to the wireless router via the second communication path.

5. The wireless network client-authentication system as claimed in claim 1, wherein the network service system further comprises an authentication module; after logging in the network service system, the connection module of the electronic device receives an authentication code via the first communication path, and then transmits the authentication code to the authentication module via the wireless router.

6. The wireless network client-authentication system as claimed in claim 5, wherein the administrator interface module further uses the authentication module to create a permit account.

7. The wireless network client-authentication system as claimed in claim 1, wherein the network service system is a social networking service (SNS) website.

8. The wireless network client-authentication system as claimed in claim 1, wherein the first communication path is a mobility protocol transmission path or a wired transmission path; the second communication path is a Wi-Fi protocol transmission path.

9. The wireless network client-authentication system as claimed in claim 8, wherein the electronic device is connected to the network service system via the wireless router with the wired transmission path to receive the connection information.

10. A wireless network connection method used in a network service system, allowing an electronic device to connect to a wireless router through the network service system, wherein the electronic device is capable of transmitting signals via a first communication path and a second communication path, the network service system having an administrator interface module for managing a client list, said method comprising the following steps:
performing an initial setup process for the wireless router, comprising:
logging in the administrator interface module of the network service system through the wireless router; and
allowing the wireless router to set a connection information and upload the connection information to the network service system, wherein the connection information comprising an encryption scheme; and
Implementing a connection process, comprising:
allowing the electronic device to connect to the network service system via the first communication path and log in the network service system by a user account;
determining whether the user account is corresponding to the client list; and
if yes, allowing the electronic device to connect to the wireless router via the second communication path with the connection information.

11. The wireless network connection method as claimed in claim 10, wherein:
the step of uploading the connection information comprising uploading a pre-shared key and a service set identifier;
if the user account being corresponding to the client list, the step of implementing connection process further comprising:
allowing the electronic device to detect the service set identifier and to receive the detected service set identifier via the first communication path; and
finding out the pre-shared key according to the service set identifier to transmit the pre-shared key to the electronic device via the first communication path, so that the electronic device is able to connect to the wireless router allowing via the second communication path.

12. The wireless network connection method as claimed in claim 10, wherein:
the step of uploading the connection information comprising uploading a service set identifier;
if the user account being corresponding to the client list, the step of implementing connection process further comprising:
allowing the electronic device to detect the service set identifier;
receiving a Media Access Control address of the electronic device and the detected service set identifier via the first communication path; and
transmitting the Media Access Control address to the wireless router having the service set identifier, so that the wireless router allowing for the electronic device to have connection via the second communication path according to the Media Access Control address.

13. The wireless network connection method as claimed in claim 10, wherein:
the step of uploading the connection information comprising uploading a service set identifier and a location information of the wireless router;
if the user account being corresponding to the client list, the step of implementing connection process further comprising:
receiving a location information of the electronic device via the first communication path; and
after comparing the location information of the electronic device and the location information of the wireless router, transmitting the service set identifier corresponding to the wireless router via the first communication path to allow the electronic device to connect to the wireless router via the second communication path.

14. The wireless network connection method as claimed in claim 10, wherein the network service system further comprises an authentication module;
if the user account, being corresponding to the client list, the step of implementing connection process further comprising:
transmitting an authentication code to the electronic device via the first communication path; and
after connecting to the wireless router via the second communication path, allowing the electronic device to transmit the authentication code to the authentication module.

15. The wireless network connection method as claimed in claim 14, further comprising the step of using the authentication module to create a permit account.

16. The wireless network connection method as claimed in claim 10, wherein the step of implementing connection process further comprising:
allowing the electronic device to connect to the network service system via the wireless router with a wired transmission path to receive the connection information.
